(19) United States
(12) Patent Application Publication
(10) Pub. No.: US 2012/0241334 A1
(43) Pub. Date: Sep. 27, 2012

(54) SHIPPING OF LIQUIDS

(75) Inventor: Brendan P. Mckenna, Southampton Hampshire (GB)

(73) Assignee: Trans Ocean Bulk Logistics Limited, Southampton Hampshire (GB)

(21) Appl. No.: 13/390,497

(22) PCT Filed: Aug. 12, 2010
(86) PCT No.: PCT/IB2010/053651

§ 371 Date: May 30, 2012

(30) Foreign Application Priority Data
Aug. 14, 2009 (GB) 0914313.2

(51) Int. Cl. B65D 6/24; B62D 21/00; B65D 21/02; B65D 6/40; B65D 85/00

(52) U.S. Cl. 206/216; 206/518; 280/781

(57) ABSTRACT

A system for shipping liquids is disclosed which comprises a container (12) which consists of two identical shells (16) the upper one of which is inverted with respect to the lower one. Toggles (32) and latches (34) are provided for pulling the two shells (16) together. The container rests on a frame, which includes pipework (44) for connecting to an inlet/outlet (26.1) in the base of the lower shell of the container. The equivalent inlet/outlet in the top of the upper shell of the container receives a gas escape vent (52). A flexible tank (46) is provided in the container (12) and the inlets/outlets communicate with the interior of the bag. The frame can, instead of accommodating just one container, be configured to support two, three or more containers in a side-by-side array.

### FIELD OF THE INVENTION

This invention relates to the shipping of liquids and particularly to the shipping of hazardous liquids.

### BACKGROUND TO THE INVENTION

The carriage of dangerous goods, including dangerous liquids, is governed by a number of International Agreements. One is the International Convention for the safety of life at sea.

A structure widely used at this time in the shipping of liquids is the ISO tank which comprises the tank proper, usually of stainless steel and cylindrical, and a strong frame which supports and protects the tank.

Another widely used structure comprises a so-called flexitank which fits in a standard shipping container.

The object of the present invention is to provide a new and improved structure which meets the requirements of all International Agreements and is more economical to produce, use and return empty than currently available structures.

### BRIEF DESCRIPTION OF THE INVENTION

According to the present invention there is provided a structure for transporting liquids, the structure comprising a rigid container comprising an upper shell and a lower shell, the shells including means for enabling the shells to be releasably attached to one another, with the upper one inverted, to form the rigid container, the shells being configured so that they nest one within the other when being transported empty, a bottom inlet/outlet for connection to a flexible tank within the container passing through the rigid container for filling and emptying purposes, and a vent at the upper end of the container passing through the container for connection to a flexible tank within the container.

The structure can further include a wheeled frame for supporting one or more of said rigid containers and facilitating loading into a shipping container. The frame is preferably composed of a number of separable parts to facilitate return shipping, and can include side members and cross members, there being a hole in at least one of the cross members and a pipe passing through the hole for connection to said bottom inlet/outlet.

In the preferred form said frame includes four cross members which provide supports for three rigid containers, three of the cross members including holes and there being pipes passing through the holes and connected to the bottom inlet/outlets of the flexible tanks.

Each shell can comprise a base, a pair of end walls which end walls extend upwardly from the base and slope outwardly, and a pair of side walls which extend upwardly from the base and slope outwardly whereby the open mouth of the shell is of greater area than the base.

Each shell can further include an outwardly directed rim which extends around those edges of the walls which bound the open mouth of the shell, the rims of two shells being in contact with one another when two shells are positioned one on the other to form a rigid container.

Skids protruding outwardly from said base both support the shell and strengthen the base.

The releasable attaching means preferably comprises latches and toggle clamps for pulling the shells together.

Each shell can be of composite polyester and glass fibre sandwich construction with a suitable strengthening core.

The present invention also provides, in combination, a structure as defined above and a flexible tank within the container, the flexible tank having a filling discharge port connected to said bottom inlet/outlet.

### BRIEF DESCRIPTION OF DRAWINGS

For a better understanding of the present invention, and to show how the same may be carried into effect, reference will now be made, by way of example, to the accompanying drawings in which:

FIG. 1 is a pictorial view of a standard ISO shipping container broken away to illustrate the structure of the present invention;

FIG. 2 illustrates three rigid containers on a frame;

FIG. 3 is a detail of the frame;

FIG. 4 is a diagrammatic cross section through a structure in accordance with the present invention and which also illustrates a flexible tank;

FIG. 5 is a pictorial view of a shell forming one half of a rigid container;

FIG. 6 is a detail showing the means for clamping two shells to one another to form a rigid container;

FIG. 7 is an underneath view of three rigid containers on a supporting frame;

FIG. 8 is a pictorial view which illustrates the frame;

FIG. 9 illustrates the components of the frame;

FIG. 10 illustrates stacked empty container shells;

FIG. 11 illustrated three sets of empty container shells stacked on a frame; and

FIG. 12 illustrates the frame and the sets of shells of FIG. 11 in a standard shipping container.

### DETAILED DESCRIPTION OF THE DRAWINGS

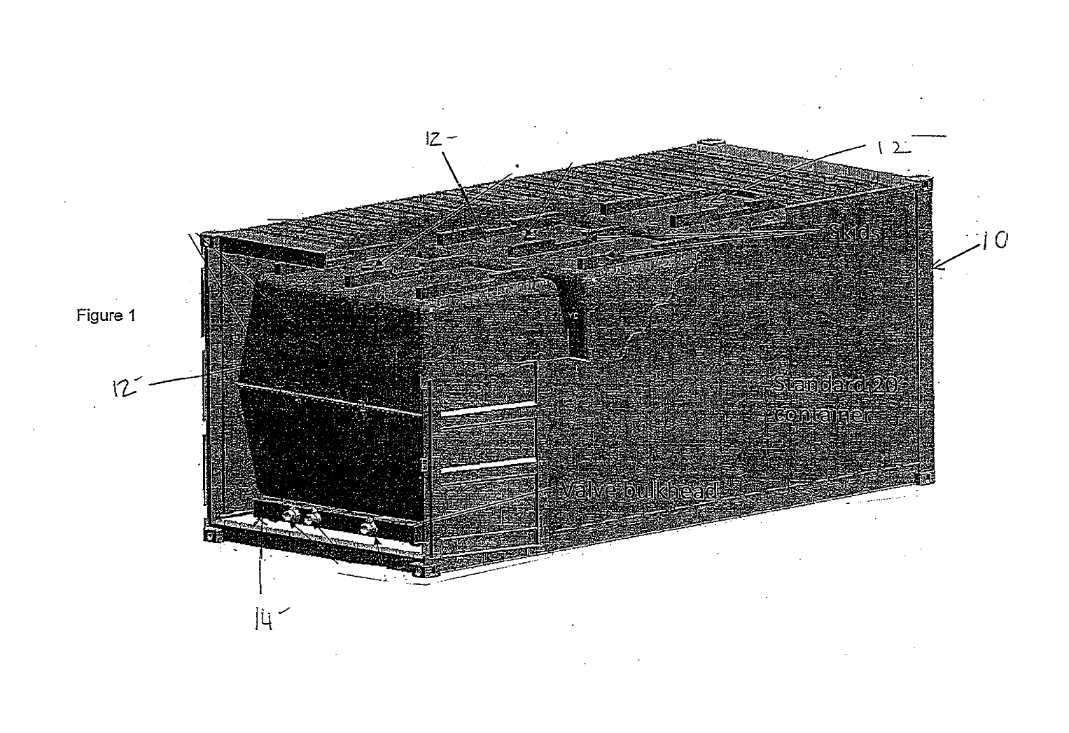

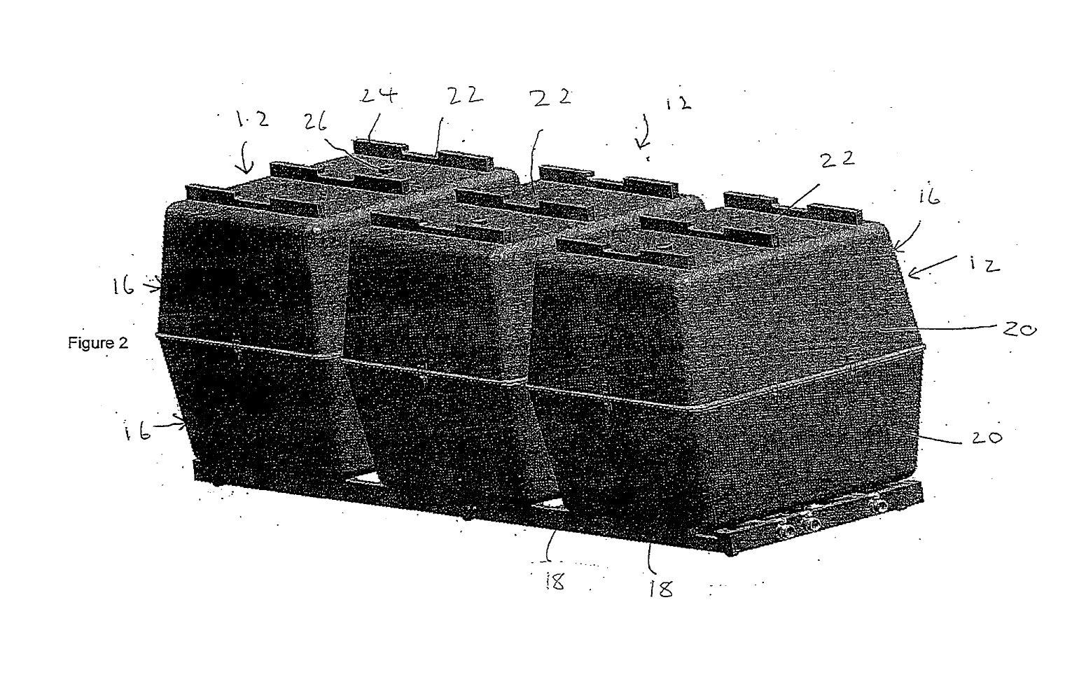

Referring first to FIGS. 1 to 5, reference numeral 10 in FIG. 1 indicates a standard ISO shipping container such as a 20 foot or 40 foot container. Three rigid containers 12 are shown within the shipping container, these being on a frame 14.

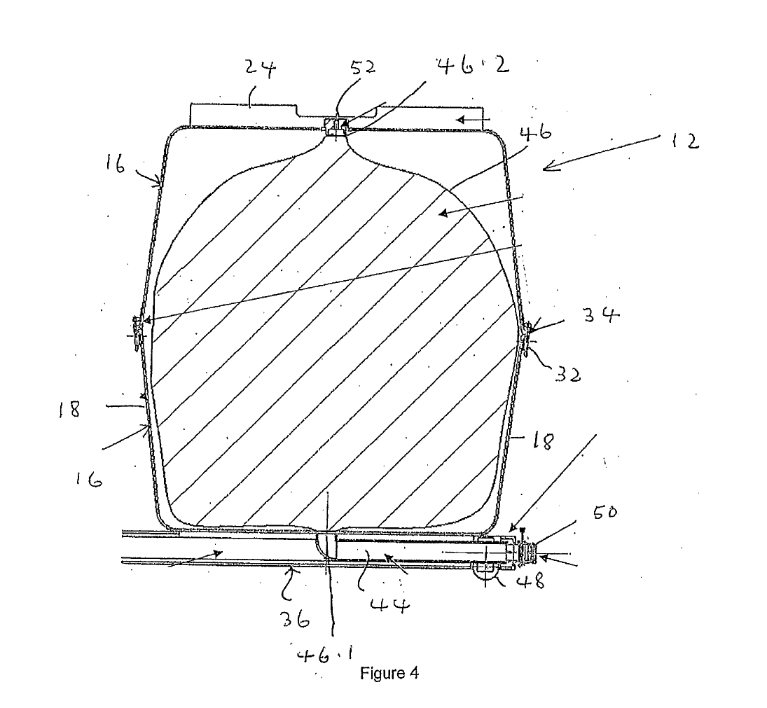

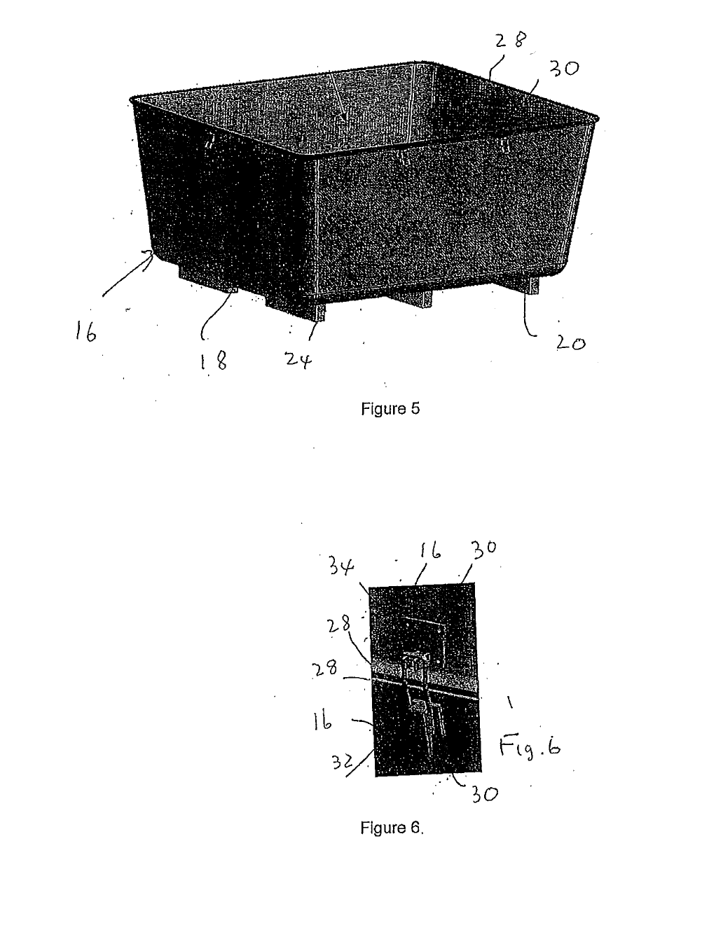

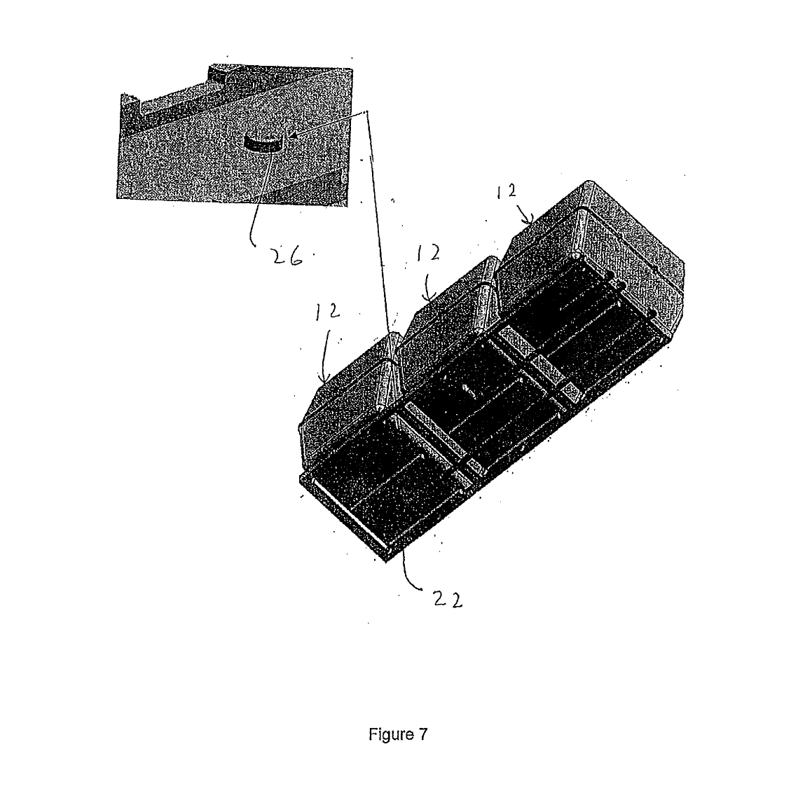

Each rigid container 12 comprises two identical shells 16 (see FIG. 5) the side and end walls 18, 20 of which slope outwardly. The upper shell is inverted with respect to the lower. Each shell 16 has a base 22 which is strengthened by transverse, parallel skids 24. Each base 22 has a circular opening in it, the openings being closed by caps 26.

An outwardly protruding rim 28 (see FIG. 6) extends around the entire periphery of each shell 16. Each shell 16 has six plates 30 secured thereto adjacent the rim 28. On one of the longer sides of each shell two toggles 32 are mounted and a further toggle 32 is mounted on one of the shorter sides. On the other of the longer sides there are two protruding latches 34 and a further protruding latch on the other of the shorter sides. The loop of each toggle 32 engages, as shown in FIG. 6, with one of the latches 34 to pull the rims of the two shells 16 into face-to-face contact.

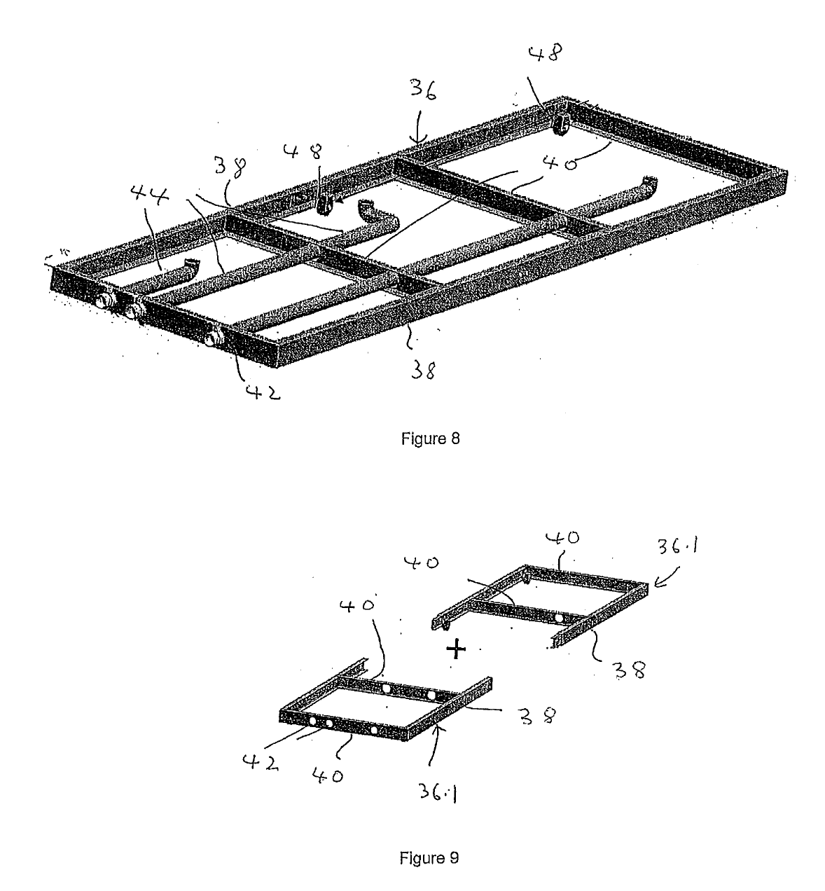

A frame for supporting these rigid containers is designated 36 (see FIGS. 8 and 9) and comprises two frame components 36.1 which interengage spigot and socket fashion. Each frame component has two side members 38 and two cross members 40. Openings 42 in the cross members 40 allow pipes 44 to extend along the frame 36.

There is a flexible tank 46 (see FIG. 4) inside each rigid container 12. The flexible tanks can be fabricated using single or multilayered synthetic plastics film having a thickness of, for example, 1200 micron. The pipes 44 are of different lengths so that each can be connected to one of the flexible tanks 46. Each flexible tank has a lower filling/discharging port 46.1 connected to the bottom inlet/outlet of the container 12 and an upper vent port 46.2.

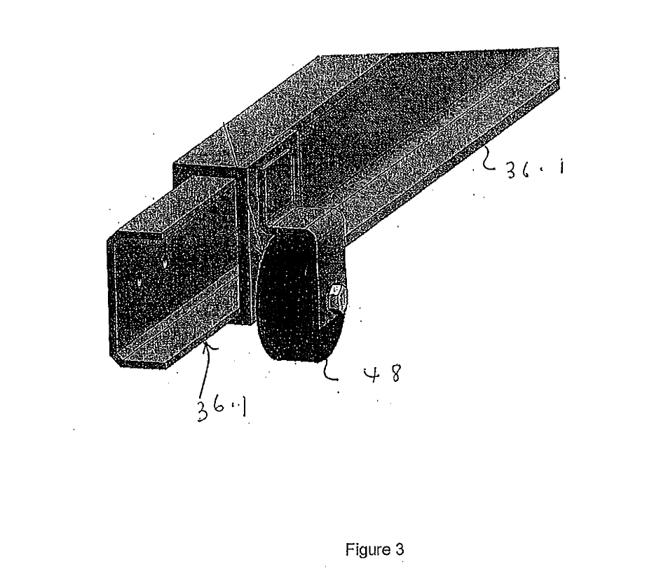

Wheels 48 (see FIGS. 3, 4 and 8) are provided on both frame components 36.1 to facilitate movement of the frame 36 with three rigid containers 12 on it into the shipping container 10.

The pipes 44 include valves 50 (see FIG. 4) which enable the flexible tanks 46 to be filled and discharged. The openings in the bases 22 of the inverted, upper shells 16 receive pressure relief vents 52 and the ports 46.2 are connected to these. In constructions having two or more rigid containers, the valves 50 can be in a bank at one end of the frame thereby permitting independent filling of the flexible tanks.

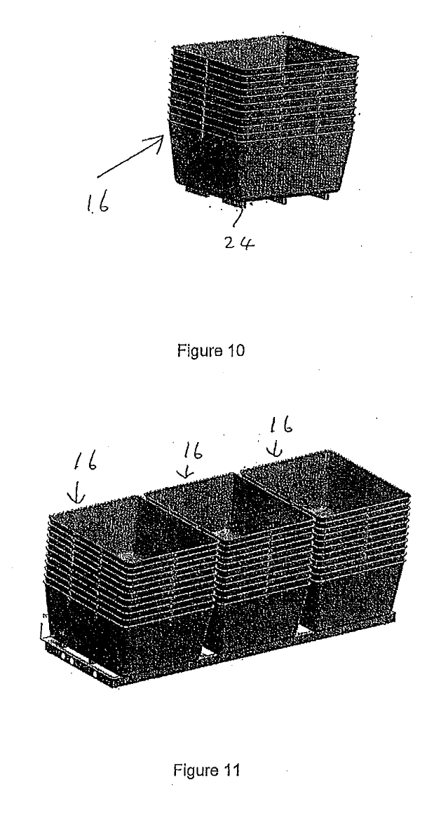

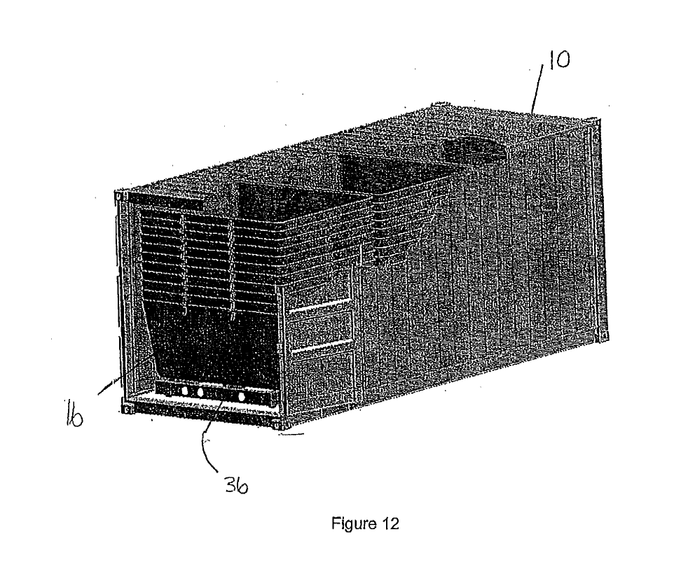

After the rigid containers 12 with the flexible tanks 46 in them have been shipped to their final destination, the tanks 46 are emptied and then detached from the shells 16. The toggle clamps 32 are released and the upper shells 16 then inverted and nested in the lower shells (see FIGS. 10 to 12). Three stacks of nested shells fit into the standard shipping container shown in FIG. 12.

In the illustrated embodiment three containers are shown on the frame. It is, however, possible for the frame to carry a single container, or two containers, or more than three containers if the liquids being shipped require it.

The port 46.1 of the tank 46 is, prior to filling, secured to the inlet/outlet opening in the lower shell. If no venting is required, and the flexible tank does not have a port 46.2, the inverted upper shell is then secured by the toggles and latches to the lower shell and the flexible tank can now be filled.

If venting is required then the tank has a port 46.2. With the upper shell held inverted above the lower shell, the port 46.2 is connected to the vent 52 which is fitted into the filling/discharge opening of the upper shell. The shells are then connected together and filling can commence.

It is preferred that the frame with the containers on it be manoeuvred into the ISO container and that thereafter filling commence through the valve or valves 50 depending on how many tanks there are. It is, however, also possible to fill the tanks before the frame and tanks are moved into the ISO container.

The frame and the containers on it can be secured to the ISO container to prevent movement. Conventional lashing means can be used.

The capacity of the containers can range between, for example, 5000 and 30000 litres.

The containers can be thermally insulated. Alternatively, or additionally, the containers can be heated. The means for heating can be electrical resistance wires embedded in the shells or passageways in the shells through which a heated medium can be circulated.

1. A structure for transporting liquids, the structure comprising a rigid container comprising an upper shell and a lower shell, the shells including means for enabling the shells to be releasably attached to one another, with the upper one inverted, to form the rigid container, the shells being configured so that they nest one within the other when being transported empty, a bottom inlet/outlet for connection to a flexible tank within the container passing through the rigid container for filling and emptying purposes, and a vent at the upper end of the container passing through the container for connection to a flexible tank within the container.

2. A structure as claimed in claim 1, and further including a wheeled frame for supporting one or more of said rigid containers and facilitating loading into a shipping container.

3. A structure as claimed in claim 2, wherein the frame is composed of a number of separable parts to facilitate return shipping.

4. A structure as claimed in claim 2, wherein the frame includes side members and cross members, there being a hole in at least one of the cross members and a pipe passing through the hole for connection to said bottom inlet/outlet.

5. A structure as claims in claim 4, wherein said frame includes four cross members which provide supports for three rigid containers, three of the cross members including holes and there being pipes passing through the holes and connected to said bottom inlet/outlets.

6. A structure as claimed in claim 1, wherein each shell comprises a base, a pair of end walls which end walls extend upwardly from the base and slope outwardly, and a pair of side walls which extend upwardly from the base and slope outwardly whereby the open mouth of the shell is of greater area than the base.

7. A structure as claimed in claim 6, wherein each shell includes an outwardly directed rim which extends around those edges of the walls which bound the open mouth of the shell, the rims of two shells being in contact with one another when two shells are positioned one on the other to form a rigid container.

8. A structure as claimed in claim 7, and including skids protruding outwardly from said base to both support the shell and strengthen the base.

9. A structure as claimed in claim 1, wherein the releasable attaching means comprises latches and toggle clamps for pulling the shells together.

10. A structure as claimed in claim 1, wherein each shell is of composite polyester and glass fibre sandwich construction.

11. A structure as claimed in claim 1, in which the shells include means for enabling them to be heated.

12. In combination, a structure as claimed in claim 1 and a flexible tank within the container, the flexible tank having a filling/discharging port connected to said bottom inlet/outlet.

13. A structure as claimed in claim 3, wherein the frame includes side members and cross members, there being a hole in at least one of the cross members and a pipe passing through the hole for connection to said bottom inlet/outlet.

14. A structure as claimed in claim 2, wherein each shell comprises a base, a pair of end walls which end walls extend upwardly from the base and slope outwardly, and a pair of side walls which extend upwardly from the base and slope outwardly whereby the open mouth of the shell is of greater area than the base.

15. A structure as claimed in claim 3, wherein each shell comprises a base, a pair of end walls which end walls extend upwardly from the base and slope outwardly, and a pair of side walls which extend upwardly from the base and slope outwardly whereby the open mouth of the shell is of greater area than the base.

16. A structure as claimed in claim 4, wherein each shell comprises a base, a pair of end walls which end walls extend upwardly from the base and slope outwardly, and a pair of side walls which extend upwardly from the base and slope outwardly whereby the open mouth of the shell is of greater area than the base.

17. A structure as claimed in claim 5, wherein each shell comprises a base, a pair of end walls which end walls extend upwardly from the base and slope outwardly, and a pair of side walls which extend upwardly from the base and slope outwardly whereby the open mouth of the shell is of greater area than the base.

18. A structure as claimed in claim 2, wherein the releasable attaching means comprises latches and toggle clamps for pulling the shells together.

19. A structure as claimed in claim 3, wherein the releasable attaching means comprises latches and toggle clamps for pulling the shells together.

20. A structure as claimed in claim 4, wherein the releasable attaching means comprises latches and toggle clamps for pulling the shells together.
